(19) United States
(12) Patent Application Publication
(10) Pub. No.: US 2004/0208438 A1
(43) Pub. Date: Oct. 21, 2004

(54) Optical routing system

(76) Inventor: Sadeg M. Faris, Pleasantville, NY (US)

Correspondence Address: REVEO, INC., 85 EXECUTIVE BOULEVARD, ELMSFORD, NY, 10523, US

(21) Appl. No.: 10/777,032

(22) Filed: Feb. 11, 2004

Related U.S. Application Data
(60) Provisional application No. 60/446,401, filed on Feb. 11, 2003.

(51) Int. Cl. G02B 6/26; G02B 6/42

(52) U.S. Cl. 385/31

(57) ABSTRACT

An optical routing system is disclosed. The optical routing system includes a substrate and at least one optical element embedded within the substrate which is configured to route optical signals. In a preferred embodiment, the optical element is a microsphere with a surface reflecting means. The optical element is configurable in any of six orthogonal directions to enable the routing of optical signals.

### CROSS-REFERENCE TO RELATED APPLICATIONS

This application claims the benefit under 35 U.S.C. §119(e) of U.S. Provisional Patent Application Serial No. 60/446,401 filed on Feb. 11, 2003, entitled “Optical Routing System,” which is herein incorporated by reference.

### TECHNICAL FIELD

The present invention relates generally to optical signal routing, and more particularly to a system for routing optical or photonic signals from node to node within a small space.

### BACKGROUND ART

The routing of optical or photonic signals from node to node within a small space can be though of in an analogous manner to printed circuit boards for electronic signals. Just as electronic technology is driven by the need for microelectronics to be faster, the routing of optical or photonic signals within a confined space can lead to faster and more efficient optical and electro-optical devices or circuits.

To take the analogy further, a typical microelectronic device includes circuit boards operably connected with various input and output devices. Conventional printed circuit boards (“PCB”) are comprised of boards having plural microelectronic devices, diodes, capacitors, etc. operably connected via plural conductors. Over the past century of electronic development, this has become the standard, without much variation in the connection between the components. Essentially, this connection has varied in terms of scale and choice of material, remaining a hard-wire connection between the components. Advancements have been made to miniaturize the wiring, even down to nano-scale dimensions. Also, improvements in materials, to increase electrical and/or thermal conductivity and enhance reliability, have been developed and are continually being sought. Other improvements with circuit boards themselves generally relate to the substrate, i.e. the material of the board itself. However, the ubiquitous hard wire electrical conductor has, in principle, essentially remained the same.

Over the past decades, much advancement has been made regarding optical or photonic devices. This advancement has primarily been regarding directing light over large distance in the form of fiber optic technology. Many solutions exist today in directing light over large distances. However, optical technology has not been as well developed for directing light over small distances. Namely, the small distances can be between optical components, or even within the optical devices themselves.

Therefore, a need remains for an optical circuit board system capable of interconnecting one or more inputs and/or outputs with one or more devices of various functionality.

### SUMMARY OF THE INVENTION

The above-discussed and other problems and deficiencies of the prior art are overcome or alleviated, and the objects of the invention are attained, by the several methods and apparatus of the present invention.

In one aspect, the invention is

The present invention provides an optical circuit board system and method capable of interconnecting one or more inputs and/or outputs with one or more devices of various functionality. Essentially, the herein invention provides an optical equivalent of printed circuit boards. Devices of various functionality may be interconnected by optical paths. Such a device, employing optical communication technologies, with their attendant performance and reliability advantages, may be provided in the space of a box or electronics.

### BRIEF DESCRIPTION OF THE DRAWINGS

The foregoing summary as well as the following detailed description of preferred embodiments of the invention, will be better understood when read in conjunction with the appended drawings. For the purpose of illustrating the invention, there is shown in the drawings embodiments which are presently preferred. It should be understood, however that the invention is not limited to the precise arrangements and instrumentalities shown. In the drawings, wherein:

FIG. 1 is a schematic diagram of the optical routing system in accordance with the principles of the invention;

FIG. 2 is a schematic diagram of the optical routing system in accordance with the principles of the invention;

FIGS. 3A and 3B is a schematic diagram of the optical routing system in accordance with the principles of the invention;

FIG. 4 is a schematic diagram of a multilayer optical printed circuit board;

FIG. 5 is a schematic diagram of an individual optical element;

FIG. 6 is a schematic diagram of an individual optical element;

FIG. 7 is a schematic diagram of an individual optical element;

FIG. 8 is a schematic diagram of an individual optical element;

FIG. 9 is a schematic diagram of the steps of the method of building the optical routing system of the invention;

FIG. 10 is a diagram of the interconnecting optical routing system of the invention; and

FIG. 11 is a schematic cross-section diagram of the optical routing substrate of the invention.

### DETAILED DESCRIPTION OF THE DRAWINGS

Disclosed herein is a photonic or optical routing substrate (“ORS”) which can be implemented in a manner that provides the optical equivalent of printed circuit board backplanes, motherboards, plug-in boards or breadboard systems in the analogous electronic domain. Manufacturing processes to create these optical substrates can be implemented to achieve low cost and high reliability. With the proper manufacturing infrastructure, ORS's could become as ubiquitous as the PCB has become.

The creation of an ORS solves the problem of how to manage optical communications over the intermediate distances—typically shorter than a meter and longer than a centimeter. In this range, systems are often constrained by physical configurations that are not present at longer distances, which can be satisfied with optical fiber, and shorter distances which can be satisfied with waveguides. In this intermediate distance, system requirements dictate routing a signal between two nodes in a very constrained, yet flexible three-dimensional path that can be ‘programmed’, at least one time, to meet the system design requirements. Neither optical fiber nor waveguide technologies satisfy this criteria, hence the lack of any type of optical backplane or mother/daughterboard technology to date.

The ORS technology overcomes these limitations by creating node-to-node optical paths within a light transmitting substrate. It will be understood that a node can be any active or passive optical element, an electro-optical connector, or any other point within an optical routing system which can provide a terminal or source for optical signals. In one embodiment, the light transmitting substrate comprises a 2 dimensional array of embedded Micro Optical Elements (“MOE”) capable of redirecting an impinging beam of light in one of 4 orthogonal directions thereby allowing the routing optical signals within a constrained two dimensional plane.

In another embodiment, the light transmitting substrate comprises a 3 dimensional array of embedded MOEs capable of redirecting an impinging beam of light in one of 6 orthogonal directions thereby allowing the routing optical signals within a constrained three dimensional volume, e.g., on the order of about 1 cm³ to 1 m³.

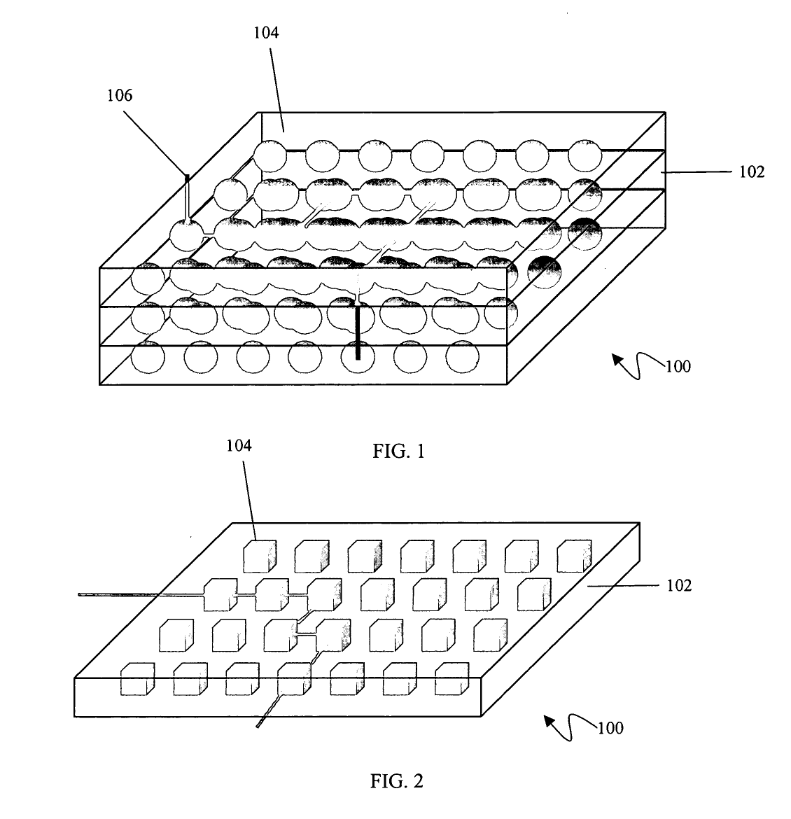

The optical routing system described herein can connect any two nodes anywhere within the substrate with a 10-40 GHz channel. Referring to FIG. 1 generally, it can be seen that exemplary path 106 can similarly be routed from any node on the substrate to any other node on the substrate.

The optical routing system disclosed has a key number of advantages over existing systems. The optical routing system herein described advantageously includes a mechanism for having a large number of simultaneous channels that are densely ‘packed’ within a single substrate. The optical routing system herein described advantageously includes a mechanism for grouping channels to create a parallel optical bus. The optical routing system herein described advantageously routes channels and buses within the substrate without interference. Signal isolation is robust within the substrate with embedded sockets in place for optical devices or connectors. It will be understood that optical signals within the system of the invention may intersect with conventional wavelength multiplexing techniques. Additionally, the optical routing system herein described is tolerant to environmental stresses and manufacturing and material variations.

Accordingly, an object of the invention is to provide an optical routing system that is flexible, robust and cost effective, and uses photons to connect components and/or devices. Another object is to provide a system having equivalent or enhanced capability as compared to the printed circuit board. Another object is to provide an optical routing system embedding active and/or passive optical devices within a board. A further object is to provide an optical routing system embedding active and/or passive optical devices within a board, wherein the devices may be “plugged” into a substrate having optical paths therein. A further object is to provide an optical routing system having the equivalent of connectors and sockets of placing devices. Still a further object is to provide an optical routing system capable of integrating optical and electrical devices.

Generally, the optical routing system comprises a regular array of optical elements embedded (partially or entirely) within a layer of material that is transparent to the light beam to be propagated therethrough. In an alternative embodiment, the system may comprise a single two-dimensional array of optical routing elements to allow optical communication between multiple nodes in the optical routing system. In certain embodiments, the system may comprise a three-dimensional array of optical elements within a substrate. The array may be formed by aligning and stacking a plurality of two-dimensional arrays of optical elements embedded in a substrate.

A method of constructing a layered substrate is also provided, with each layer having a regular array of embedded optical elements, wherein the substrate material is optically transparent, and the optical elements can be oriented at least one time (and in certain preferred embodiments automatically and programmatically) whereby the array of optical elements are physically fixed in specific orientations to achieve a specific routing path. The substrate layers, with their embedded optical elements, can be aligned and stacked so that optical signals can be routed between layers as well as within a layer.

This layered substrate can take any optical signal originating at any of the optical element nodes and route it to any other optical element node. In non-combinatory optical systems (e.g., wherein plural optical signals are not processed at any one node within the optical system), multiple signals can be routed simultaneously as long as they do not intersect at a node. With a sufficient density of nodes, many hundreds or thousands of optical signals can be routed from node to node in an analogous fashion as a PCB routes electrical signals.

The layered substrate may also be constructed with one or more optical devices therein, to transform, combine, split, or otherwise process an optical signal, and route said processed signal to any node within the system, for processing by an external device or for processing by another optical device therein.

In one embodiment, the communication system may be on the order of several centimeters in length and width, with a thickness suitable to support the optical routing elements, which may be, e.g., on the order of a few millimeters in diameter in the case of spherical optical routing elements, whereby the optical routing elements are spaced approximately a centimeter apart.

In a further embodiment, plural optical routing substrates may be stacked, forming multi-layer substrates. The optical routing elements are aligned and oriented so that they redirect an impinging light beam along a path that has been predetermined with a routing algorithm based on the requisite system design. With a sufficiently dense array of optical routing elements in a multi-layer configuration, a large number of simultaneous and independent optical communication channels (lightpaths) can be accommodated.

The following table outlines different ORS components and their equivalence to comparable PCB structures. It should be noted that the following table is intended merely for illustrative purposes only.

| PCB Tachnology | ORS Technology |
|---|---|
| Substrate | Substrate |
| Layer | Layer |
| Circuit | Lightpath |
| Dielectric | Optically Transparent Material-e.g. |
| | Acrylic |
| Conductor | MOE |
| Socket | Optical Socket |
| Connector | Optical Connector |
| Pad | Entry/Exit Lightpath |
| Via | Interlayer Lightpath |
| Trace | Interlayer Lightpath |
| Device, chip or IC | Optical component |

One difference between a PCB and an ORS is that the routing nodes (i.e. the places where the signal changes direction) are discrete and predetermined in an ORS whereas in a PCB they can theoretically be anywhere. In practice, however, the routing of a complex PCB places constraints upon where and how signals can be ‘deflected’ that are very similar to the regular array of optical routing elements in the ORS.

Referring now to FIG. 1, there is shown an optical routing system 100 in accordance with the principles of the invention. Generally, the optical routing system 100 includes one or more substrate layers 102, each layer 102 having an array of optical elements 104. The substrate layers 102 are generally transparent to the frequency of light signals to be transmitted therethrough, or contain paths within the substrate that are voided or contain optically transparent material.

The optical elements 104 are configured and positioned so as to reflect an input light signal through, e.g., a lightpath 106 between several optical elements 104 as illustrated in FIG. 1. Ultimately, this signal may be routed to an external optical device, or to an optional optical processing device also embedded within the substrate (not shown).

Layers can be stacked creating multi-layer substrates. The optical elements 104 are aligned and oriented so that they redirect an impinging light beam along a path that has been predetermined. In one embodiment, a routing algorithm may be used to determine the path for the system design. With a sufficiently dense array of optical elements 104 in a multi-layer configuration, a large number of simultaneous and independent optical communication channels (lightpaths) can be accommodated.

As depicted in FIG. 1, the optical elements 104 are generally in the form of spheres. However, it is contemplated that the present invention may utilize optical elements of other shapes. For example, and referring now to FIG. 2, an optical routing substrate 200 is shown having optical elements 204 in the form of cubes. Any other suitable shape may be used. The optical elements 104 or 204 generally include a suitable reflection means, such as a mirror or other reflective surface, to direct light to another optical element, another device, or to an output, e.g., for communication with an external device. In general, each optical element is constructed so that it enables a precise orientation and redirection of light with minimal dispersion and attenuation in a specific direction. When positioned correctly, an optical element redirects light in one of 6 orthogonal directions.

Embodiments of the optical elements shown herein are not intended to be limiting. For example, optionally, the reflection means may be switchable, e.g., between transparent and reflective mode, scattering and reflective mode, or absorptive and reflective mode. Alternatively, programmable or selectively actuatable MEMs may be used in the array configuration within the substrate.

The optical elements may be positioned once (e.g., upon initial manufacturing) and programmably configured positioned (e.g., wherein the optical elements 104 or 204 include MEMs or other active). Alternatively, and in certain embodiments, the positioning of the optical elements may be determined during assembly of the substrate and optical elements, as described further herein in certain embodiments.

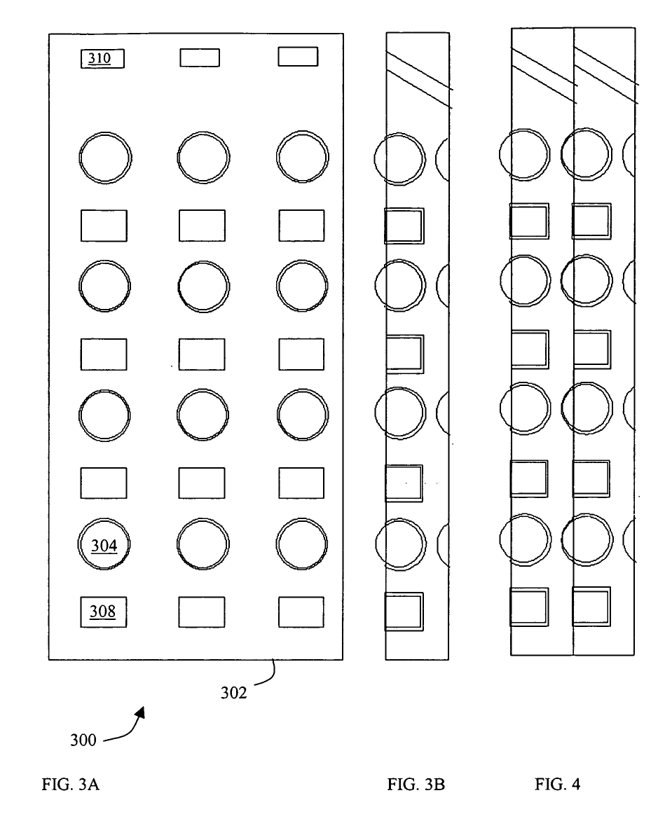

Referring now to FIGS. 3A and 3B, further embodiments of an optical routing system 300 are depicted. The optical routing system 300 includes a substrate 302 capable of transmitting light therethrough, and in a direction parallel to the major surfaces of such substrate. The substrate 302 has a first array of spheres 304 of diameter D and spaced apart by a period P. The spheres 304 are generally capable of being programmed to rotate in different directions so that light incident on it from −x direction can be routed to propagate in the +/−y direction, +/−z direction or +/−x direction (wherein −x direction is reflected).

In one embodiment, each sphere 304 is capable of being set (temporarily or permanently) in one of several positions to provide the desired path within the substrate. The sphere 304 is positioned in a corresponding socket in the substrate, filled with a fluid that matches the index of the substrate. The fluid can solidified to fix the sphere in a position corresponding to a desired lightpath direction. This may be automated by an appropriate programming system. The programming system can be manual, electromechanical, electromagnetic to rotate the sphere into the desired position prior to setting within the substrate.

In another embodiment, the sphere 304 controllably rotates in a corresponding socket in the substrate. For example, suitable electromagnetic systems, MEMs or other systems capable of controllably rotating the optical elements may be provided.

The substrate 302 also has an array of cavities 308 located between spheres. The cavities 308 may be identical or different in shape. The cavities 308 may be filled by functional blocks, which generally carry out optical processing functions that may be passive, active, or have a null function to allow light to pass through it. Optical processing functions including but not limited to, amplification, digital or analog processing, modulation, deflections, Fourier transform, filtering, and combinations comprising at least one of the foregoing functionalities may be performed on light passing through each functional block.

Each functional block is immersed in a cavity 308 that may be filled with a fluid that is matched to the substrate to minimize reflections. Alternatively, any optical devices within cavities 308 may be permanently formed within the substrate 302.

The substrate 302 further includes one or more input ports 310, which couple the input light to be processed. This port may be another cavity that has walls at an angle with respect to the surface of the substrate, so that an internal reflecting surface is created. This wall provides an opportunity for the incoming light beam to couple allowing propagation substantially parallel to the substrate surface using a total internal reflection system.

Referring now to FIG. 4, a multilayer (N Layers) optical printed circuit board may be created by stacking N substrates described above that are appropriately aligned and bonded (permanently or temporarily) to each other.

As shown in FIG. 4, the sockets of one optical backplane are interconnected within corresponding cavities in adjacent optical backplanes. This interconnection provides optical interconnection between stacked optical backplanes. In one embodiment, the optical interconnect is through the socket and the socket cavity (either through optically transparent material forming the substrate or passages formed therethrough). In another embodiment, the optical interconnect is through freespace outside the plane of the substrate.

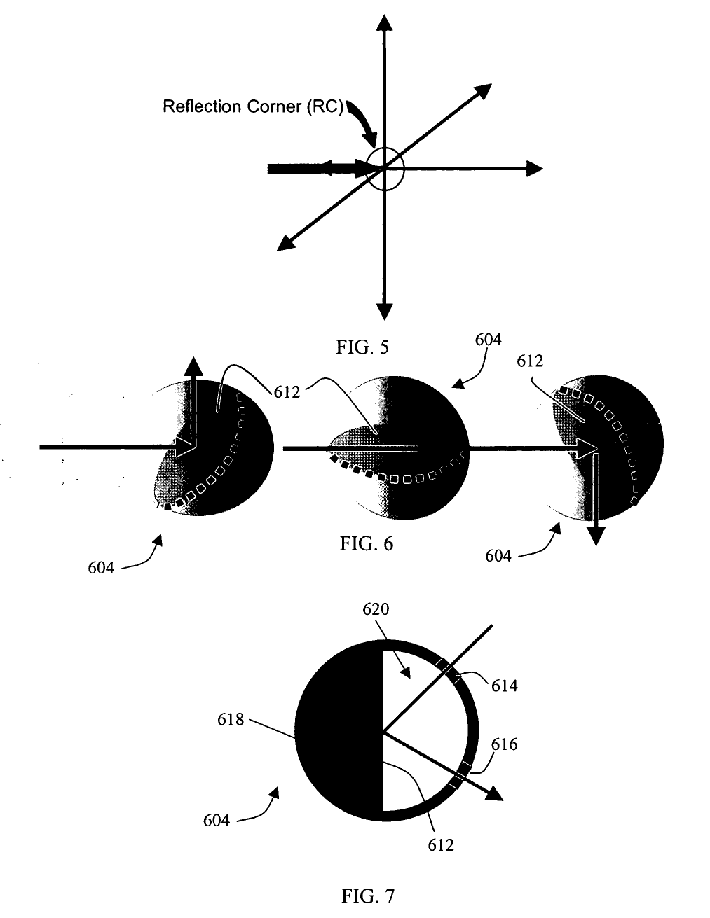

Within the three dimensional volume, to properly route light (e.g., assuming no combinatory functions are provided), the optical elements 104/204 or microspheres 304 must redirect light along a predetermined path from node to node in a manner that is independent of other light paths within the same substrate (i.e., eliminating path intersection). Referring now to FIG. 5, there is shown a schematic diagram of an individual optical element. Each of the optical elements 104/204 or spheres 304 may include a reflection corner. Each reflection corner as depicted, changes the optical path of light 90 degrees in one of six directions (assuming direct reflection). An array of these reflection corners, configured appropriately, allows node to node optical communication within the optical routing system.

In one embodiment, each optical element including the reflection corner is independently programmed or positioned within the substrate during assembly to direct light in one of 5 directions (6 including reflection) and locked in place to create a fixed routing environment. The internal interconnect network routes an optical signal via a series of these independently configured reflection corners to transmit it from source to sink.

In a preferred embodiment, the series of optical elements including reflection corners are positioned, configured and locked so as to minimize attenuation and divergence. This clearly becomes more critical as the number of steps increases. With precise positioning, even a series of 100 or more reflection corners may be used to route optical signals with minimal loss.

One embodiment of an optical element including a reflection corner is shown in FIGS. 6 and 7. As shown in FIG. 6, an optical element 604 is in the form of a sphere or a micro-sphere that reflects or transmits incoming light depending on the orientation of the sphere. In particular, the orientation of the reflection surface 612 within the sphere determines the direction of the exiting light beam.

Referring now to FIG. 7, the optical element 604 is shown in more detail. For example, the optical element 604 may be formed from an acrylic material having the same refractive index as the substrate. A plurality of windows 614, 616 are provided in optical communication with the reflective surface 612 for entry and exit of light. A suitable number of windows may be provided in order to allow for the desired number of inputs and outputs for each optical element 604.

The internal reflection surface 612 may be formed by joining two hemispheres, one of which includes the reflective surface 612. The other hemisphere 618 may be formed of optically transparent material. Alternatively, the hemisphere without the reflective surface 612 may contain air or may include a vacuum chamber 620. Accordingly, an internal mirror surface may be formed.

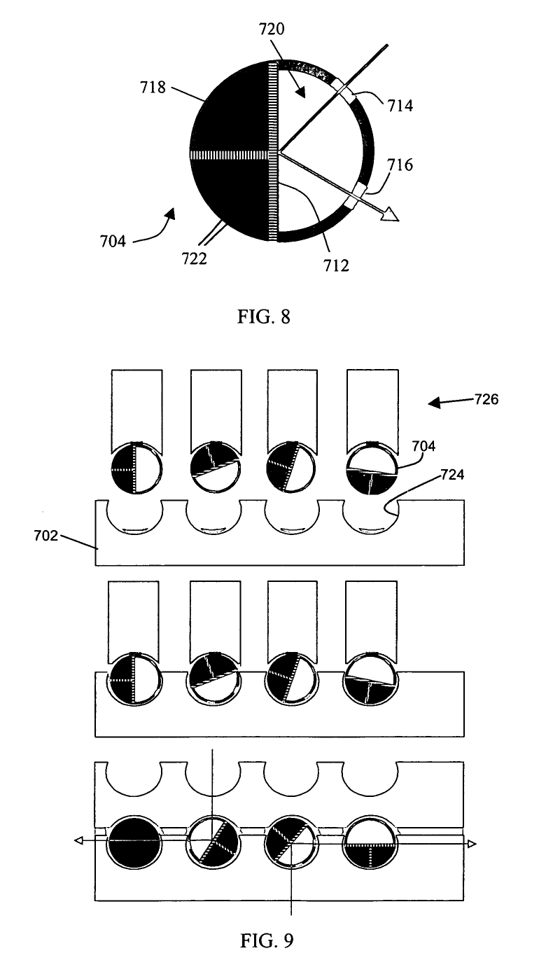

Referring now to FIG. 8, an optical element 704 is shown, which is similar to the optical element 604, but includes encoder bands 722. These may be physical marks, e.g., that are optically aligned during manufacture to orient the spheres. Optionally, these encoder bands may be active, e.g., including data encoding, that is readable by suitable means.

Referring now to FIG. 9, a method of constructing an optical routing system is shown. Generally, the optical elements 704 are placed and oriented within a substrate layer 702. This is accomplished through the following process herein described.

First, a transparent layer 702 (e.g., acrylic or other suitable material) is formed that contains a 2D array of sockets 724. A liquid, preferably UV curable polymer, is subsequently index matched to the layer material and placed into the sockets 724. Subsequent optical elements 704 are placed into the sockets 724 using an array of micro-manipulators 726.

The micro-manipulators 726 are prespecified into orientation for the optical elements 704. The orientation of the optical elements 704 is then fixed by UV curing the liquid polymer. The top surface of the layer with liquid polymer is subsequently coated.

Another layer 702 is placed on top and bonded by curing liquid polymer. If necessary, the steps above described are repeated as needed. Repeat these steps for number of layers needed.

The result is an exemplary optical routing system which, in a preferred embodiment, has the following physical characteristics. Each layer is approximately 50 cm by 50 cm in dimension. A total of six layers are stacked together to exhibit a total thickness between 12-15 mm. A design rule of 2 mm optical elements are placed on 5 mm centers. Each layer has approximately 100×100 MOEs.

The fixing of the optical elements creates a one-time programmable set of light paths that is equivalent to the routing of electrical signals in a PC Board. Routing software may be created to translate a system design into an optimal routing path for the optical signals. This routing is no more complex, and in many ways simpler, than the routing of traces on PC Boards.

Optical routing within the substrate may be accomplished by various methods. For example, in one embodiment, lightpaths within the backplane substrate may form freespace channels between the spheres. These lightpaths may be open channels, fiber optics, optical waveguides, or the like. In another embodiment, the material of the substrate is substantially optically transparent, or has suitable index matching, so as to allow optical communication between inputs, spheres and/or devices within the optical backplane.

It is envisioned that current manufacturing infrastructure could be adapted to construct the optical substrates described herein, thereby facilitating industry adoption of this new technology. It is desirable to manufacture the optical substrates of materials and in a manner that allows the optical alignment of the substrate and the board interconnects to remain robust in the face of thermal and mechanical stresses.

As described above, the microspheres are embedded within sockets in the substrate. For example, in one embodiment, the microspheres may generally be about 0.5 mm in diameter, which is enclosed in a 1 mm diameter socket filled with a transmissive, curable polymer. The microspheres themselves may be constructed within the sockets (e.g. two halves joined together). Alternatively, the sockets may be manufactured around the microspheres, and the sockets having microspheres therein are inserted into the substrate.

Various optical devices may be associated with the herein described optical routing system, either as components therein (e.g., as shown in FIGS. 3A, 3B and 4), as external devices routed with the herein described optical routing system, or both. Exemplary devices include, but are not limited to, attenuators, wavelength multiplexors, wavelength demultiplexors, polarizers, detectors; optical to electrical signal converters, switches, processors, MEMs, mirrors, modulators, amplifiers, microchannel plates, lenses, collimators, lasers, cameras (e.g., CCD); filters; waveguides; resonators; light emitting diodes; encoders; decoders; IR receivers/transmitters; or any other optical device.

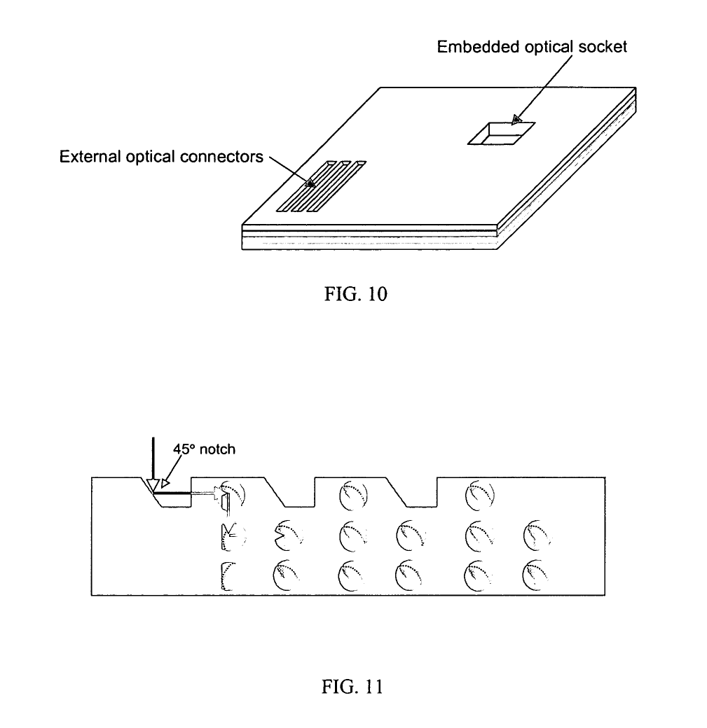

Referring now to FIG. 10, a system for interconnecting an optical routing system or the present invention to optical and electro-optic components and devices is shown. With the optical routing system, this is accomplished through external optical sockets and connectors that are created in the top and bottom layers of the ORS.

As shown in FIG. 11, the interconnect into the optical routing system can be through a notch in the top or bottom layer of the optical routing system or through a ‘window’ in the top or bottom layer that is aligned with the optical element array. A notch provides an efficient interconnect mechanism.

While preferred embodiments have been shown and described, various modifications and substitutions may be made thereto without departing from the spirit and scope of the invention. Accordingly, it is to be understood that the present invention has been described by way of illustrations and not limitation.

What is claimed is:

1. An optical routing system for routing optical signals between nodes, said system comprising:
a substrate; and
at least one optical element embedded within said substrate, said optical element configured to route said optical signals,
wherein said optical element is configurable in any one of six orthogonal directions.

2. The optical routing system of claim 1 wherein said substrate is transparent.

3. The optical routing system of claim 1 wherein said at least one optical element is configured as a node.

4. The optical routing system of claim 1 wherein said at least one element is arranged in an array.

5. The optical routing system of claim 4 wherein said array is two-dimensional.

6. The optical routing system of claim 4 wherein said array is three-dimensional.

7. The optical routing system of claim 1 wherein said at least one optical element is a microsphere.

8. The optical routing system of claim 1 wherein said substrate is multilayered.

9. The optical routing system of claim 1 wherein said optical signals are routed in a prespecified configuration.

10. The optical routing system of claim 2 wherein said transparent substrate is transparent to the wavelength of said optical signals.

11. The optical routing system of claim 1 wherein said at least one optical element is spherical.

12. The optical routing system of claim 11 wherein said at least one optical element includes a surface reflecting means.

13. An optical routing system comprising:
a substrate having an optical path interconnecting at least one input with at least one optical device via a configurable optical router; and
at least a portion of the optical device and the configurable optical router within a substrate.

14. An optical backplane comprising a substrate having an optical path interconnecting at least one input with at least one optical device via a configurable sphere, at least the optical device and the configurable sphere within a substrate

15. The optical backplane of claim 14 wherein said spheres are positioned in optical alignment between optical backplanes for optical interconnection therebetween.

16. The optical backplane of claim 14 wherein said spheres are positioned within cavities in the substrate.

17. The optical backplane of claim 14, wherein said spheres are configurable with a selectively curable adhesive.
